(19) United States
(12) Patent Application Publication
(10) Pub. No.: US 2008/0288335 A1
(43) Pub. Date: Nov. 20, 2008

(54) Home valuator

(76) Inventor: Neal J. GOLDBERG, Duxbury, MA (US)

Correspondence Address: MUIRHEAD AND SATURNELLI, LLC, 200 FRIBERG PARKWAY, SUITE 1001, WESTBOROUGH, MA, 01581, US

(21) Appl. No.: 12/152,132

(22) Filed: May 12, 2008

Related U.S. Application Data
(60) Provisional application No. 60/965,706, filed on Aug. 22, 2007.
(60) Provisional application No. 60/930,888, filed on May 18, 2007.

(51) Int. Cl. G06Q 10/00

(52) U.S. Cl. 705/10

(57) ABSTRACT

A system for estimating home and property values is based upon current market data including recent comparable properties sold. The comparable sales may be chosen based on their proximity to the subject and their similarity in building and land assessments by the town or city in which the property is located, among other factors. The sale prices of the comparable properties may be adjusted based on the differences in assessments and appreciation rates from the time of sale to the date of valuation. This may be called an automated valuation model (AVM).

### RELATED APPLICATIONS

This application claims priority to U.S. Provisional App. No. 60/965,706 filed Aug. 22, 2007 and 60/930,888 filed May 18, 2007, which are both incorporated herein by reference.

### TECHNICAL FIELD

This application is related to the field of value estimation and, more particularly, to a system and method for estimating values of homes and other properties.

### BACKGROUND OF THE INVENTION

Determining property values is an important task in the real estate industry. Real estate buyers, sellers and professionals all have an interest in determining an accurate value for a home or other property in the marketplace. Inaccurate property value determinations may result in lost profits or delayed sales. Sales of comparable properties may provide an indication of a subject property's value; however, it may be difficult to consistently compile and process complete information about comparable properties in order to make accurate property value determinations.

Accordingly, it would be desirable to provide a system that facilitates an efficient, consistent and unbiased process for valuing homes or other properties.

### SUMMARY OF THE INVENTION

According to the system described herein, a method for estimating a value of a subject property includes selecting comparable properties that are comparable to the subject property according to at least one factor. Sale values may be obtained for at least some of the comparable properties. The sale values of the comparable properties are adjusted to generate adjusted sale values. The value of the subject property is estimated using the adjusted sale values. The at least one factor may include at least one of: property type, distance from the subject property, assessment of a comparable property, and sale date of the comparable property. Obtaining sale values of the comparable properties includes: applying at least one criterion to the comparable properties, discarding comparable properties that do not satisfy the at least one criterion, and obtaining sale values for remaining comparable properties. Satisfying the at least one criterion includes at least one of: being of a same property type, being within a specified distance, being within at least one specified time period, and having different buyer and seller last names for a comparable property.

Adjusting the sale values of the comparable properties to generate adjusted sale values may include determining appreciation values according to sale dates of the comparable properties. Adjusting the sales values may also include establishing a plurality of time periods in connection with a date of valuation of the subject property, and adjusting the sale values of the comparable properties according to the time period in which each of the sale dates of the comparable properties fall. The plurality of time periods may include a first time period and a second time period, the first time period being a period closest to the date of valuation of the subject property and the second time period being a period longer than the first time period. Adjusting the sale values of the comparable properties to generate adjusted sale values may also include determining a gross difference in assessed value according to differences in assessments between the comparable properties and the subject property. Obtaining sale values of at least some of the comparable properties may include determining, for each of the comparable properties, a ratio of sale value divided by total assessment value, determining a mean value and a standard deviation of the ratios for all the comparable properties, and discarding comparable properties having a ratio value that exceeds a standard deviation threshold. Estimating the value of the subject property may include dividing the total of the adjusted sale values by a number of the comparable properties for which adjusted sale values were determined.

According further to the system described herein, a computer readable medium storing executable code that includes executable code that selects comparable properties that are comparable to the subject property according to at least one factor. Executable code may be included that obtains sale values of at least some of the comparable properties. Executable code may be included that adjusts the sale values of the comparable properties to generate adjusted sale values. Executable code may be included that estimates the value of the subject property using the adjusted sale values. The at least one factor may include at least one of: property type, distance from the subject property, assessment of a comparable property, and sale date of the comparable property. The executable code that obtains sale values of the comparable properties may include executable code that applies at least one criterion to the comparable properties, executable code that discards comparable properties that do not satisfy the at least one criterion, and executable code that obtains sale values for remaining comparable properties. Satisfying the at least one criterion may include at least one of: being of a same property type, being within a specified distance, being within at least one specified time period, and having different buyer and seller last names for a comparable property.

The executable code that adjusts the sale values of the comparable properties to generate adjusted sale values may include determining appreciation values according to sale dates of the comparable properties. The executable code that adjusts the sale values may include executable code that establishes a plurality of time periods in connection with a date of valuation of the subject property, and executable code that adjusts the sale values of the comparable properties according to the time period in which each of the sale dates of the comparable properties fall. The plurality of time periods may include a first time period and a second time period, the first time period being a period closest to the date of valuation of the subject property and the second time period being a period longer than the first time period. The executable code that adjusts the sale values of the comparable properties to generate adjusted sale values may include executable code that determines a gross difference in assessed value according to differences in assessments between the comparable properties and the subject property. The executable code that obtains sale values of at least some of the comparable properties may include executable code that determines, for each of the comparable properties, a ratio of sale value divided by total assessment value, determines a mean value and a standard deviation of the ratios for all the comparable properties, and discards comparable properties having a ratio value that exceeds a standard deviation threshold. The executable code that estimates the value of the subject property may include executable code that divides the total of the adjusted sale values by a number of the comparable properties for which adjusted sale values were determined.

According further to the system described herein, an automated system for estimating a value of a subject property includes at least one processor, a communication device that obtains information from a database, wherein the information is accessible to the at least one processor, and a computer readable medium storing executable code executable by the at least one processor. The computer readable medium may include executable code that selects comparable properties that are comparable to the subject property according to at least one factor. Executable code may be included that obtains sale values of at least some of the comparable properties. Executable code may be included that adjusts the sale values of the comparable properties to generate adjusted sale values. Executable code may be included that estimates the value of the subject property using the adjusted sale values.

### BRIEF DESCRIPTION OF THE DRAWINGS

Embodiments of the system described herein are explained in detail with reference to the several figures of the drawings, which are briefly described as follows.

FIG. 1 is a flow diagram showing a process for estimating a value of a property in accordance with an embodiment of the system described herein.

FIG. 2 is a flow diagram showing a process for evaluating a comparable property sale according to an embodiment of the system described herein.

FIG. 3 is a flow diagram showing a process for determining appreciation in connection with estimating a value of a property in accordance with another embodiment of the system described herein.

FIG. 4 is a schematic illustration of an automated system for estimating a value of a subject property according to an embodiment of the system described herein.

### DETAILED DESCRIPTION OF VARIOUS EMBODIMENTS

Using current market data, the system described herein provides for estimation of a property value based upon recent comparable properties sold. In various embodiments, the comparable property sales may be chosen based on their proximity to the subject and their similarity in building and land assessments by the town or city in which the property is located, among other factors. The sale prices of the comparable properties may be adjusted based on the differences in assessments and appreciation rates from the time of sale to the date of valuation, as further discussed elsewhere herein. This may be referred to as an automated valuation model (AVM).

Factors for a subject property being evaluated, and/or for comparable properties to the subject property, that may be used in connection with the system described herein may include: date of valuation, longitude, latitude, sale date of a comparable property, land assessment, building assessment, buyer and seller names of comparable properties, and property type. Further, the system may be configurable according to location. For example, in an embodiment, only properties in a selected town may be used as comparable properties. Alternatively, in another embodiment, properties from other size regions may be used, for example, such properties within larger local and/or metro regions.

One or more of the above-noted factors, including various combinations of factors selected for specific towns and/or regions, may be used in connection with estimating a property value, as further discussed elsewhere herein. In connection with embodiments of the system discussed herein, information related to the above-noted factors may be may be manually input by a user and/or may be automatically supplied or retrieved from one or more databases over a network. For example, the network may be an internal network, such as an intranet, and/or an external network, such as the Internet, and the databases may include public and/or private databases.

Referring now to the figures of the drawing, the figures comprise a part of this specification and illustrate exemplary embodiments of the described system. It is to be understood that in some instances various aspects of the system may be shown schematically or may be shown exaggerated or altered to facilitate an understanding of the system.

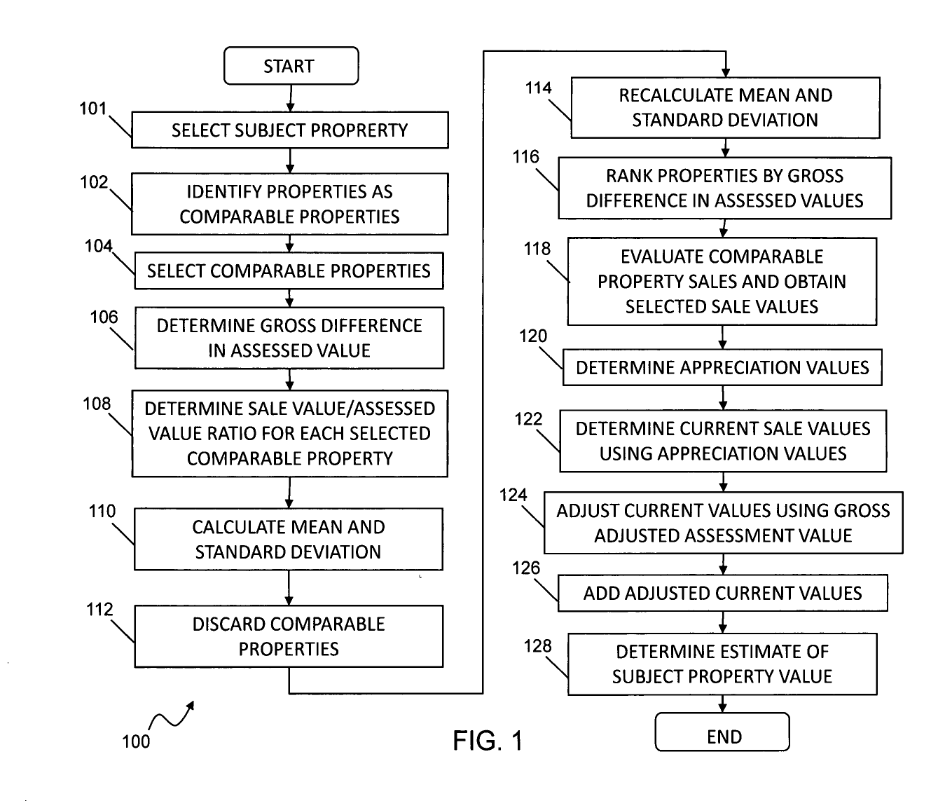

FIG. 1 is a flow diagram 100 for a process for estimating a value of a home and/or other property. At a step 101, a subject property may be selected, for example at a particular address. After the step 101, processing proceeds to a step 102 where properties that are comparable to the subject property are identified as comparable properties. In various embodiments, the comparable properties to the subject property may be identified using one or more of the factors noted elsewhere herein. After the step 102, processing proceeds to a step 104 where comparable properties are selected. Comparable properties may be selected based on various criteria. In an embodiment, a comparable property may be selected if it is within a specified distance of the subject property, e.g. within a distance threshold, by converting the longitude and latitude of each property to a difference in miles. The specified distance within which a comparable property is selected may be configurable. For example, the specified distance may relate to properties within a particular town and/or may be configured to include properties within larger areas or regions.

Further, a comparable property may be selected if a sale date of the comparable property is within one of two time periods of the date of valuation. For example, the two time period measures that may be used are a leading time period (shorter term period) and a lagging time period (longer term period). For example, a leading time period may be within one year of the date of valuation and a lagging time period may be from one year to two years of the date of valuation. Determination of the lengths of the leading and lagging time periods may be configurable. Use of the leading and lagging time periods are further discussed elsewhere herein. Further, it should be noted that more than two periods may also be used in connection with the system described herein. For example, each of the leading and lagging time periods may be further divided into multiple time periods, such as four time periods, and processing described herein may be performed with respect to each of these time periods in accordance with the system described herein. Other comparable properties may be selected according to various criteria and requirements, for example, comparable properties may be selected according to whether or not the buyer and seller have the same last name, among other factors. A limit on the number of selected comparable properties used to estimate a subject property's value may also be imposed in connection with the system described herein.

After the step 104, processing proceeds to a step 106 where a gross difference in assessed value of each selected comparable property relative to the subject property may be determined. The gross difference in assessed value may be calculated using the absolute value of the building assessment difference between a selected comparable property and the subject property plus the absolute value of the land assessment difference between the flagged comparable property and the subject property. After the step 106, processing proceeds to a step 108 where, for each selected comparable property sold within the lagging time period (longer time frame) of the date of valuation, the ratio of its sale to total assessed value may be determined, assuming the total assessed value of the comparable property is greater than 0. After the step 108, processing proceeds to a step 110 where, using the comparable properties sold within the lagging time period of the date of valuation identified in step 108, the mean and standard deviation of the comparable properties sale values divided by the total assessed value minus one is calculated.

After the step 110, processing proceeds to a step 112 where each comparable property sold during the lagging period whose sale value divided by total assessed value falls greater than three standard deviations from the previously calculated mean value are discarded from the calculation process. Although the discarding procedure described involves three standard deviations, other thresholds may be used in connection with the system described herein. After the step 112, processing proceeds to a step 114 where the standard deviation and mean of the remaining comparable properties' sale values divided by the total assessed value minus one is recalculated.

In other embodiments, in connection with the steps 108 and 110, the described processes may also be applied to properties sold within the leading time period as well as the lagging period and/or according to other appropriate periods. Further, in other embodiments, the steps 112 and 114 may be performed more than once in connection with the system described herein.

After the step 114, processing proceeds to a step 116 where the comparable properties are ranked according to the gross difference in assessed value of the subject property compared to the comparable property sales. After the step 116, processing proceeds to a step 118 where comparable property sales are evaluated in relation to the subject property according to certain criteria, and sale values are obtained for selected comparable property sales. The evaluation of the comparable property sales may be based on whether the comparable property sales occurred during the leading period or the lagging period. Embodiments of the step 118 are further discussed elsewhere herein.

After the step 118, processing proceeds to a step 120, where appreciation values may be determined. In an embodiment, quarterly appreciation values may be used to adjust the comparable sale price to a estimated current value for each of the comparable property sales. Other embodiments for determining appreciation adjustment according to the step 120 are further discussed elsewhere herein. After the step 120, processing proceeds to a step 122 where the selected comparable property sales values are adjusted according to the appreciation value to reflect the current value of each of the comparable properties as of the date of valuation.

After the step 122, processing proceeds to a step 124 where the estimated current comparable property sale value may be adjusted based on the gross difference in assessed value relative to the subject property. After the step 124, processing proceeds to a step 126 where the adjusted current comparable property sale values may be added together to generate a total for the adjusted current comparable property sale values. After the step 126, processing proceeds to a step 128 where an estimated value of the subject property is obtained, for example by taking the total of the adjusted current comparable property sale values divided by the total number of comparable properties selected. Other algorithms for estimating the value of the subject property may be used in connection with the system described herein based on the adjusted current comparable property sale values. After the step 128, processing is complete.

It should be noted that the steps described herein may be performed in other appropriate orders and times different than that identified above in accordance with the system described herein. For example, the step 106 for determining the gross difference in assessed values may be performed in a different order in connection with the processing described herein. Further, for example, the step 120 for determining appreciation may be performed in a different order in connection with the processing described herein, including being performed before the step 101. Further, in various embodiments, one or more of the steps described herein may be repeated and/or omitted in connection with valuation determinations under appropriate circumstances in accordance with the system described herein.

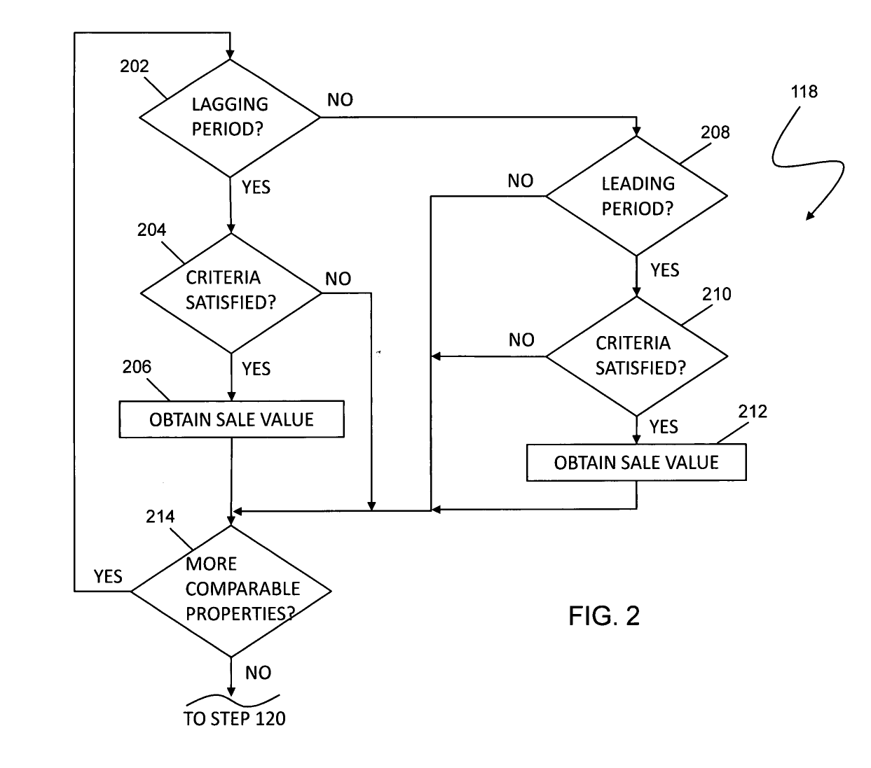

FIG. 2 is a flow diagram further describing the step 118 of FIG. 1 and showing processes for evaluating comparable property sales according to an embodiment of the system described herein. At a test step 202, it is determined whether the comparable property sale is within the lagging period. If so, then processing proceeds to a test step 204 where it is determined whether the comparable property sale falls within specified criteria. The criteria may include whether a specified number of standard deviations from the mean have exceeded a threshold, whether the comparable property total assessed value is not 0, whether comparable property sale is within a specified distance of the subject property, whether the comparable property sale's buyer and seller last name are not the same, and whether the comparable property and subject property are of the same property type, among other criteria. In various embodiments, all of the above-noted criteria may be required to be satisfied or, alternatively, only certain of the above-noted criteria may be required to be satisfied.

If the required criteria are satisfied for the comparable property sale being evaluated at the test step 204, then processing proceeds to a step 206 where the sale value of the selected comparable property is obtained. After the step 206, or alternatively after the test step 204 if the criteria are not satisfied, processing proceeds to a test step 214 where it is determined if there are additional comparable properties to evaluate. If so, then processing proceeds back to the step 202. If not, then processing proceeds to the step 120 for determining appreciation values, as further discussed elsewhere herein.

If at the test step 202, it is determined that the comparable property sale date is not within the lagging period of the date of valuation, then processing proceeds to a test step 208 where it is determined whether the comparable property sale date is within leading period of the date of valuation. If so, then processing proceeds to a test step 210 where it is determined if the comparable property sale satisfies the indicated criteria. In an embodiment, the criteria may be whether the comparable sales buyer and seller last name are not the same and whether the comparable property and subject property are of the same property type. Other criteria may also be used, including other of the criteria discussed elsewhere herein. If at the test step 210 it is determined that the comparable property sale in the leading period satisfies indicated criteria, then processing proceeds to a step 212 where the sale value of the comparable property in the leading period is obtained. After the step 212, processing proceeds to the test step 214 where it is determined if there are additional comparable properties to evaluate. If at the test step 208 it is determined that the comparable property sale date is not within the lagging period or if at the test step 210 it is determined that indicated criteria are not satisfied, then processing proceeds to the test step 214.

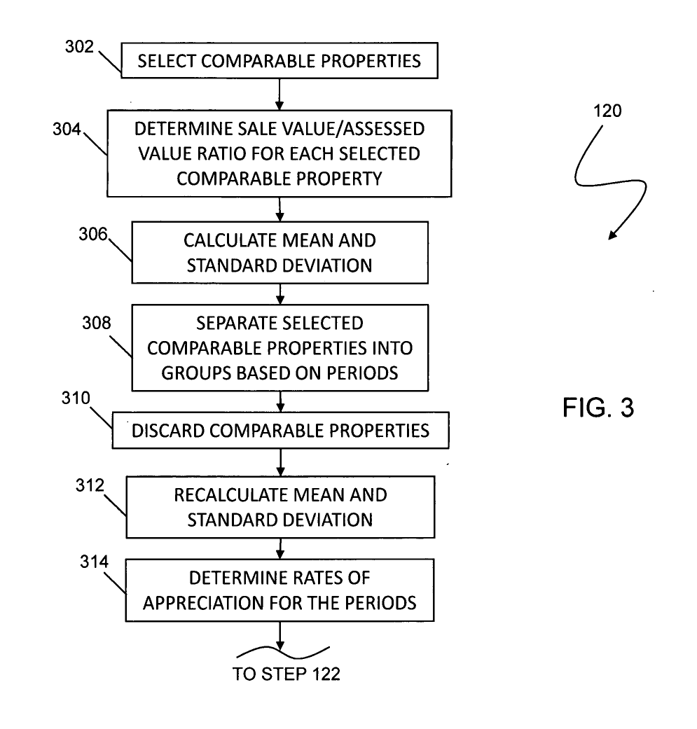

FIG. 3 is a flow diagram illustrating an embodiment for the step 120 for determining appreciation to reflect the current value as of the date of valuation in accordance with the system described herein. At a step 302, comparable properties are selected based on a time proximity to the date of valuation. For example, a comparable property sold with a given time frame may be used based on a specified date of valuation. After the step 302, processing proceeds to a step 304, where, for each selected comparable property, the ratio: (sale price)/(total assessed value) is calculated. After the step 304, processing proceeds to a step 306 where the mean of the ratios and standard deviation for the selected comparable properties is calculated.

After the step 306, processing proceeds to the a step 308, where the selected comparable properties are separated into groups based on date periods prior to the specified date of valuation. After the step 308, processing proceeds to a step 310 where comparable properties from the groups are discarded based on a number of standard deviations from the calculated mean sales/assessed ratio value. For example, a comparable property having a sale value/assessed ratio value more than three standard deviations from the mean may be discarded. Other standard deviation thresholds may be used. After the step 310, processing proceeds to a step 312 where the mean sales/assessed ratio are recalculated for each period. In other embodiments, the steps 310 and 312 may be performed more than once. After the step 312, processing proceeds to a step 314 where, for each period, the percent difference in the ratio value from the previous period is determined. For example, the mean sales/assessed ratio for the previous period is subtracted from the mean sales/assessed ratio of a period of interest, and the result is divided by the mean sales/assessed ratio of the previous period, that is: (mean_salesassessedratio2−mean_salesassessedratio1)/mean_salesassessedratio1. The percentage difference represents the rate of appreciation for that period. After the step 314, processing proceeds to the step 122 where the selected comparable property sales values are adjusted according to the appreciation value to reflect the current value of each of the comparable properties as of the date of valuation, as further discussed elsewhere herein.

Any or all of the steps described herein may be performed by a computer having a processor and memory and/or other computer readable medium that stores executable code that may be executed by a processor to perform the tasks and processes described herein. In various embodiments, information used by the system described herein may be manually input by a user and/or may be automatically supplied or retrieved from one or more databases, for example using a network such as an intranet or the Internet.

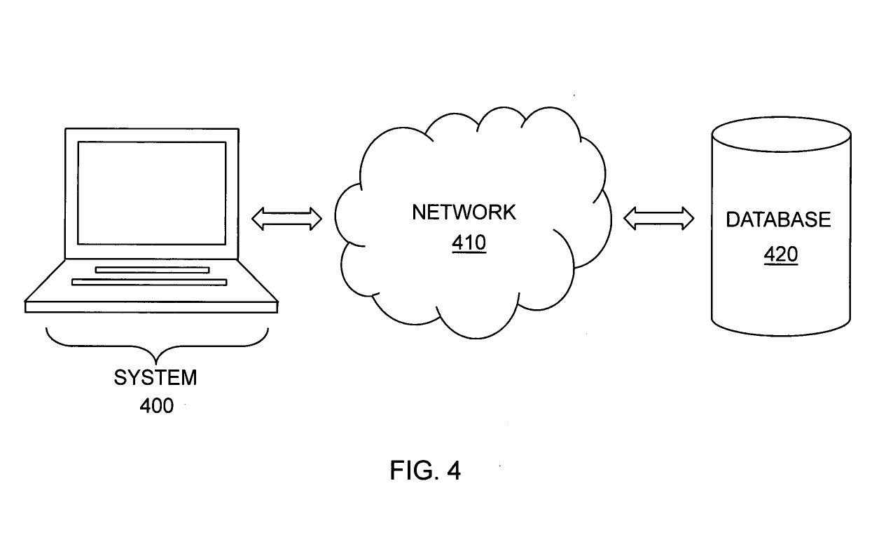

FIG. 4 is a schematic illustration of an automated system 400 for estimating a value of a subject property according to an embodiment of the system described herein. The automated system 400 may be coupled, via a network 410, to a database 420. The automated system 400 may include a computer having one or more processors and a memory. The automated system 400 may include a communication device, such as a wireless communication device and/or other device for connecting to the network 410, such as the Internet, that communicates with the database 420 via the network 410. The communication device of the automated system 400 may download information from the database 420 to store on the automated system 400, for example in memory, for use in connection with the processes described herein. The one or more processors of the automated system 400 may access the information downloaded from the database 420 and use the information in connection with executing an application and/or or other code stored in memory, and/or other computer readable medium, on the system 400 for performing the processes for estimating a property value described herein. The automated system 400 may be used in connection with an interface, for example a software interface provided by running a computer application and/or via a web-based interface, that may display results of property value estimation processes to a user and/or that provides an interface through which a user may configure the system, including controlling, adjusting and/or monitoring data collection and/or calculations by the system, as further discussed elsewhere herein.

The automated valuation model (AVM) according to the system described herein may be used by individuals, companies, organizations and/or government entities that need to value a property, including, for example, banks, mortgage companies, wall street firms that have purchased lenders, auction sites, real estate offices, buyers, sellers, investors, attorneys, municipal assessor's offices, and government departments, such as the Department of Revenue, and/or other individuals and entities. The AVM according to the system described herein may be used by the individuals and/or other entities in multiple ways. For example, banks and mortgage companies may use the AVM: (1) to find out approximate value of properties for purpose of collateral in evaluating loan applications; (2) to review actual appraisals performed; (3) for primary valuation for lending purposes (instead of an actual appraisal); and/or (4) for portfolio review. Real estate offices may use the AVM to: (1) help with market analysis (on both the buying and selling side); and/or (2) provide indications of what an appraiser might use as comparable properties. Auction sites may use the AVM to offer a service to real estate investors so potential auction bidders may have information about the value of properties that are to be bid upon. Individuals may use the AVM to find out the value of certain properties, whether buying or selling, and may obtain a report from a website, for example on a pay-per-report basis. Attorneys may use the AVM to find out values of properties for division of assets and potential tax abatements. Assessors' offices may use the AVM to find out if mistakes have been made in their assessments. Government departments of revenue may use AVM to find out if there are mistakes in assessments. Further, other uses are possible in connection with the system described herein.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method for estimating a value of a subject property, comprising:
selecting comparable properties that are comparable to the subject property according to at least one factor;
obtaining sale values of at least some of the comparable properties;
adjusting the sale values of the comparable properties to generate adjusted sale values; and
estimating the value of the subject property using the adjusted sale values.

2. The method according to claim 1, wherein the at least one factor includes at least one of: property type, distance from the subject property, assessment of a comparable property, and sale date of the comparable property.

3. The method according to claim 1, wherein obtaining sale values of at least some of the comparable properties includes:
applying at least one criterion to the comparable properties;
discarding comparable properties that do not satisfy the at least one criterion;
obtaining sale values for remaining comparable properties.

4. The method according to claim 3, wherein satisfying the at least one criterion includes at least one of: being of a same property type, being within a specified distance, being within at least one specified time period, and having different buyer and seller last names for a comparable property.

5. The method according to claim 1, wherein adjusting the sale values of the comparable properties to generate adjusted sale values includes determining appreciation values according to sale dates of the comparable properties.

6. The method according to claim 1, wherein adjusting the sale values of the comparable properties to generate adjusted sale values includes:
establishing a plurality of time periods in connection with a date of valuation of the subject property;
adjusting the sale values of the comparable properties according to the time period in which each of the sale dates of the comparable properties fall.

7. The method according to claim 6, where the plurality of time periods includes a first time period and a second time period, the first time period being a period closest to the date of valuation of the subject property and the second time period being a period longer than the first time period.

8. The method according to claim 1, wherein adjusting the sale values of the comparable properties to generate adjusted sale values includes determining a gross difference in assessed value according to differences in assessments between the comparable properties and the subject property.

9. The method according to claim 1, wherein obtaining sale values of at least some of the comparable properties includes determining, for each of the comparable properties, a ratio of sale value divided by total assessment value, determining a mean value and a standard deviation of the ratios for all the comparable properties, and discarding comparable properties having a ratio value that exceeds a standard deviation threshold.

10. The method according to claim 1, wherein estimating the value of the subject property includes dividing the total of the adjusted sale values by a number of the comparable properties for which adjusted sale values were determined.

11. A computer readable medium storing executable code for estimating a value of a subject property, the computer readable medium comprising:
executable code that selects comparable properties that are comparable to the subject property according to at least one factor;
executable code that obtains sale values of at least some of the comparable properties;
executable code that adjusts the sale values of the comparable properties to generate adjusted sale values; and
executable code that estimates the value of the subject property using the adjusted sale values.

12. The computer readable medium according to claim 11, wherein the at least one factor includes at least one of: property type, distance from the subject property, assessment of a comparable property, and sale date of the comparable property.

13. The computer readable medium according to claim 11, wherein the executable code that obtains sale values of at least some of the comparable properties includes:
executable code that applies at least one criterion to the comparable properties;
executable code that discards comparable properties that do not satisfy the at least one criterion;
executable code that obtains sale values for remaining comparable properties.

14. The computer readable medium according to claim 13, wherein satisfying the at least one criterion includes at least one of: being of a same property type, being within a specified distance, being within at least one specified time period, and having different buyer and seller last names for a comparable property.

15. The computer readable medium according to claim 11, wherein the executable code that adjusts the sale values of the comparable properties to generate adjusted sale values includes determining appreciation values according to sale dates of the comparable properties.

16. The computer readable medium according to claim 11, wherein the executable code that adjusts the sale values of the comparable properties to generate adjusted sale values includes:
executable code that establishes a plurality of time periods in connection with a date of valuation of the subject property;
executable code that adjusts the sale values of the comparable properties according to the time period in which each of the sale dates of the comparable properties fall.

17. The computer readable medium according to claim 16, where the plurality of time periods includes a first time period and a second time period, the first time period being a period closest to the date of valuation of the subject property and the second time period being a period longer than the first time period.

18. The computer readable medium according to claim 11, wherein the executable code that adjusts the sale values of the comparable properties to generate adjusted sale values includes executable code that determines a gross difference in assessed value according to differences in assessments between the comparable properties and the subject property.

19. The computer readable medium according to claim 11, wherein the executable code that obtains sale values of at least some of the comparable properties includes executable code that determines, for each of the comparable properties, a ratio of sale value divided by total assessment value, determines a mean value and a standard deviation of the ratios for all the comparable properties, and discards comparable properties having a ratio value that exceeds a standard deviation threshold.

20. An automated system for estimating a value of a subject property, comprising:
at least one processor;
a communication device coupled to the at least one processor that obtains information from a database, wherein the information is accessible by the at least one processor;
a computer readable medium storing executable code that is executable by the at least one processor, the computer readable medium including:
executable code that select comparable properties that are comparable to the subject property according to at least one factor;
executable code that obtains sale values of at least some of the comparable properties;
executable code that adjusts the sale values of the comparable properties to generate adjusted sale values; and
executable code that estimates the value of the subject property using the adjusted sale values.
